(19) United States
(12) Patent Application Publication
(10) Pub. No.: US 2026/0303713 A1
(43) Pub. Date: Oct. 1, 2026

(54) ACKNOWLEDGED AND NON-ACKNOWLEDGED COMMUNICATIONS

(71) Applicant: QUALCOMM Incorporated, San Diego, CA (US)

(72) Inventor: Linhai HE, San Diego, CA (US)

(21) Appl. No.: 19/577,230

(22) Filed: Mar. 24, 2026

Related U.S. Application Data
(60) Provisional application No. 63/778,370, filed on Mar. 26, 2025.

(51) Int. Cl. H04L 69/322; H04L 5/00

(52) U.S. Cl. CPC H04L 69/322; H04L 5/0055

(57) ABSTRACT

Some communications systems may perform retransmissions for increased reliability of packet delivery or may perform communications without retransmissions for increased throughput or reduced latency. In some examples, a communications system may operate in accordance with an acknowledged mode or an unacknowledged mode in radio link control (RLC) transmission. However, it may not be efficient to achieve a target reliability via hybrid automatic repeat request (HARQ) alone. Too many retransmissions may result in a loss in throughput or increased delay. In some use cases, mixed modes of transmission may be helpful. Some examples of the techniques described herein may provide one or more RLC transmission modes, in which an RLC entity (e.g., single RLC entity) may transmit some PDUs unacknowledged while others may be delivered with acknowledgment.

### CROSS REFERENCE

This Patent Application claims the benefit of U.S. Provisional Patent Application No. 63/778,370 by HE, entitled “ACKNOWLEDGED AND NON-ACKNOWLEDGED COMMUNICATIONS,” filed Mar. 26, 2025, assigned to the assignee hereof, and expressly incorporated herein.

### TECHNICAL FIELD

This disclosure relates generally to wireless communication, and more specifically to systems, devices, methods, and techniques associated with acknowledged and non-acknowledged communications.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method by a device is described. The method may include communicating configuration information indicating a mixed mode of radio link control (RLC) operation for acknowledged and non-acknowledged protocol data unit (PDU) communication, transmitting a set of RLC PDUs based on the mixed mode of RLC operation, where a first subset of the set of RLC PDUs is associated with an acknowledged mode based on the configuration information and a second subset of the set of RLC PDUs is associated with a non-acknowledged mode based on the configuration information, and where the second subset is different from the first subset, and receiving acknowledgment information for the first subset of the set of RLC PDUs in accordance with the acknowledged mode.

A device is described. The device may include a processing system that includes processor circuitry and memory circuitry that stores code. The processing system may be configured to cause the device to communicate configuration information indicating a mixed mode of RLC operation for acknowledged and non-acknowledged PDU communication, transmit a set of RLC PDUs based on the mixed mode of RLC operation, where a first subset of the set of RLC PDUs is associated with an acknowledged mode based on the configuration information and a second subset of the set of RLC PDUs is associated with a non-acknowledged mode based on the configuration information, and where the second subset is different from the first subset, and receive acknowledgment information for the first subset of the set of RLC PDUs in accordance with the acknowledged mode.

Another device is described. The device may include means for communicating configuration information indicating a mixed mode of RLC operation for acknowledged and non-acknowledged PDU communication, means for transmitting a set of RLC PDUs based on the mixed mode of RLC operation, where a first subset of the set of RLC PDUs is associated with an acknowledged mode based on the configuration information and a second subset of the set of RLC PDUs is associated with a non-acknowledged mode based on the configuration information, and where the second subset is different from the first subset, and means for receiving acknowledgment information for the first subset of the set of RLC PDUs in accordance with the acknowledged mode.

A non-transitory computer-readable medium storing code is described. The code may include instructions executable by one or more processors (e.g., directly, indirectly, without pre-processing, after pre-processing) to communicate configuration information indicating a mixed mode of RLC operation for acknowledged and non-acknowledged PDU communication, transmit a set of RLC PDUs based on the mixed mode of RLC operation, where a first subset of the set of RLC PDUs is associated with an acknowledged mode based on the configuration information and a second subset of the set of RLC PDUs is associated with a non-acknowledged mode based on the configuration information, and where the second subset is different from the first subset, and receive acknowledgment information for the first subset of the set of RLC PDUs in accordance with the acknowledged mode.

Some examples of the method, devices, and non-transitory computer-readable medium described herein may further include operations, features, means, or instructions for transmitting the set of RLC PDUs includes transmitting a first RLC PDU of the set of RLC PDUs with a sequence number and a second RLC PDU of the set of RLC PDUs without a sequence number and receiving the acknowledgment information includes receiving acknowledgment or negative acknowledgment (ACK/NACK) information corresponding to the first RLC PDU.

Some examples of the method, devices, and non-transitory computer-readable medium described herein may further include operations, features, means, or instructions for receiving an indication of a quantity of received RLC PDUs of the second subset, where a first quantity of acknowledged PDUs and a second quantity of non-acknowledged RLC PDUs may be based on a probability corresponding to a packet error rate (PER) of the quantity of received RLC PDUs.

Some examples of the method, devices, and non-transitory computer-readable medium described herein may further include operations, features, means, or instructions for receiving a negative acknowledgment (NACK) for one or more RLC PDUs of the first subset of the set of RLC PDUs and transmitting the one or more RLC PDUs of the first subset of the set of RLC PDUs.

Some examples of the method, devices, and non-transitory computer-readable medium described herein may further include operations, features, means, or instructions for receiving a PDU for a subset of unsuccessfully received RLC PDUs, where the subset of unsuccessfully received RLC PDUs may be based on a response probability associated with the set of RLC PDUs.

In some examples of the method, devices, and non-transitory computer-readable medium described herein, the response probability may be indicated via the configuration information.

In some examples of the method, devices, and non-transitory computer-readable medium described herein, the response probability may be from a range of response probabilities and the range of response probabilities may be indicated via the configuration information.

In some examples of the method, devices, and non-transitory computer-readable medium described herein, an RLC PDU of the set of RLC PDUs may be associated with one of the acknowledged mode or the non-acknowledged mode based on a rule at an RLC layer after a service data unit (SDU) corresponding to the RLC PDU may be submitted from a packet data convergence protocol (PDCP) layer to the RLC layer.

In some examples of the method, devices, and non-transitory computer-readable medium described herein, the rule includes a threshold that may be indicated via the configuration information, and the RLC PDU of the set of RLC PDUs may be communicated in accordance with one of the acknowledged mode or the non-acknowledged mode based on whether a PDU set importance (PSI) of the RLC PDU satisfies the threshold.

In some examples of the method, devices, and non-transitory computer-readable medium described herein, the rule may be based on a PDU type condition, and the RLC PDU of the set of RLC PDUs may be communicated in accordance with one of the acknowledged mode or the non-acknowledged mode based on whether a type of the RLC PDU satisfies the PDU type condition.

Some examples of the method, devices, and non-transitory computer-readable medium described herein may further include operations, features, means, or instructions for generating a random quantity, where the rule may be based on a probability, and the RLC PDU of the set of RLC PDUs may be communicated in accordance with one of the acknowledged mode or the non-acknowledged mode based on a comparison of the probability and the random quantity.

In some examples of the method, devices, and non-transitory computer-readable medium described herein, the probability may be indicated via the configuration information.

In some examples of the method, devices, and non-transitory computer-readable medium described herein, a range of probabilities may be indicated via the configuration information.

In some examples of the method, devices, and non-transitory computer-readable medium described herein, the first subset of the set of RLC PDUs may be communicated with one or more sequence numbers and the second subset of the set of RLC PDUs may be communicated without a sequence number.

In some examples of the method, devices, and non-transitory computer-readable medium described herein, the configuration information indicates a probability of an RLC PDU of the set of RLC PDUs being an acknowledged RLC PDU or a non-acknowledged RLC PDU.

Some examples of the method, devices, and non-transitory computer-readable medium described herein may further include operations, features, means, or instructions for communicating capability information indicating a capability to communicate with the mixed mode of operation for acknowledged and non-acknowledged RLC PDU communication, where the configuration information may be transmitted based on the capability information.

A method by a device is described. The method may include communicating configuration information indicating a mixed mode of RLC operation for acknowledged and non-acknowledged PDU communication, receiving a set of RLC PDUs based on the mixed mode of RLC operation, where a first subset of the set of RLC PDUs is associated with an acknowledged mode based on the configuration information and a second subset of the set of RLC PDUs is associated with a non-acknowledged mode based on the configuration information, and where the second subset is different from the first subset, and transmitting acknowledgment information for the first subset of the set of RLC PDUs in accordance with the acknowledged mode.

A device is described. The device may include a processing system that includes processor circuitry and memory circuitry that stores code. The processing system may be configured to cause the device to communicate configuration information indicating a mixed mode of RLC operation for acknowledged and non-acknowledged PDU communication, receive a set of RLC PDUs based on the mixed mode of RLC operation, where a first subset of the set of RLC PDUs is associated with an acknowledged mode based on the configuration information and a second subset of the set of RLC PDUs is associated with a non-acknowledged mode based on the configuration information, and where the second subset is different from the first subset, and transmit acknowledgment information for the first subset of the set of RLC PDUs in accordance with the acknowledged mode.

Another device is described. The device may include means for communicating configuration information indicating a mixed mode of RLC operation for acknowledged and non-acknowledged PDU communication, means for receiving a set of RLC PDUs based on the mixed mode of RLC operation, where a first subset of the set of RLC PDUs is associated with an acknowledged mode based on the configuration information and a second subset of the set of RLC PDUs is associated with a non-acknowledged mode based on the configuration information, and where the second subset is different from the first subset, and means for transmitting acknowledgment information for the first subset of the set of RLC PDUs in accordance with the acknowledged mode.

A non-transitory computer-readable medium storing code is described. The code may include instructions executable by one or more processors (e.g., directly, indirectly, without pre-processing, after pre-processing) to communicate configuration information indicating a mixed mode of RLC operation for acknowledged and non-acknowledged PDU communication, receive a set of RLC PDUs based on the mixed mode of RLC operation, where a first subset of the set of RLC PDUs is associated with an acknowledged mode based on the configuration information and a second subset of the set of RLC PDUs is associated with a non-acknowledged mode based on the configuration information, and where the second subset is different from the first subset, and transmit acknowledgment information for the first subset of the set of RLC PDUs in accordance with the acknowledged mode.

Some examples of the method, devices, and non-transitory computer-readable medium described herein may further include operations, features, means, or instructions for receiving the set of RLC PDUs includes receiving a first RLC PDU of the set of RLC PDUs with a sequence number and a second RLC PDU of the set of RLC PDUs without a sequence number and transmitting the acknowledgment information includes transmitting ACK/NACK information corresponding to the first RLC PDU.

Some examples of the method, devices, and non-transitory computer-readable medium described herein may further include operations, features, means, or instructions for transmitting an indication of a quantity of received RLC PDUs of the second subset, where a first quantity of acknowledged PDUs and a second quantity of non-acknowledged RLC PDUs may be based on a probability corresponding to a PER of the quantity of received RLC PDUs.

Some examples of the method, devices, and non-transitory computer-readable medium described herein may further include operations, features, means, or instructions for transmitting a PDU for a subset of unsuccessfully received RLC PDUs, where the subset of unsuccessfully received RLC PDUs may be based on a response probability associated with the set of RLC PDUs.

In some examples of the method, devices, and non-transitory computer-readable medium described herein, the response probability may be indicated via the configuration information.

In some examples of the method, devices, and non-transitory computer-readable medium described herein, the response probability may be from a range of response probabilities and the range of response probabilities may be indicated via the configuration information.

In some examples of the method, devices, and non-transitory computer-readable medium described herein, an RLC PDU of the set of RLC PDUs may be associated with one of the acknowledged mode or the non-acknowledged mode based on a rule at an RLC layer after a SDU corresponding to the RLC PDU may be submitted from a PDCP layer to the RLC layer.

In some examples of the method, devices, and non-transitory computer-readable medium described herein, the first subset of the set of RLC PDUs may be communicated with one or more sequence numbers and the second subset of the set of RLC PDUs may be communicated without a sequence number.

In some examples of the method, devices, and non-transitory computer-readable medium described herein, the configuration information indicates a probability of an RLC PDU of the set of RLC PDUs being an acknowledged RLC PDU or a non-acknowledged RLC PDU.

Some examples of the method, devices, and non-transitory computer-readable medium described herein may further include operations, features, means, or instructions for communicating capability information indicating a capability to communicate with the mixed mode of operation for acknowledged and non-acknowledged RLC PDU communication, where the configuration information may be transmitted based on the capability information.

### BRIEF DESCRIPTION OF THE DRAWINGS

FIG. 1 shows an example of a wireless communication system.

FIG. 2 shows an example of devices that supports acknowledged and non-acknowledged communications.

FIG. 3 shows an example of devices that supports acknowledged and non-acknowledged communications.

FIG. 4 shows an example of a process flow that supports acknowledged and non-acknowledged communications.

FIG. 5 shows an example of a process flow that supports acknowledged and non-acknowledged communications.

FIG. 6 shows a block diagram of a processing system that supports acknowledged and non-acknowledged communications.

FIG. 7 shows a diagram of a system including a device that supports acknowledged and non-acknowledged communications.

FIGS. 8 through 11 show flowcharts illustrating methods that support acknowledged and non-acknowledged communications.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some communications systems may perform retransmissions for increased reliability of packet delivery or may perform communications without retransmissions for increased throughput or reduced latency. In some examples, a communications system may operate in accordance with an acknowledged mode or an unacknowledged mode in radio link control (RLC) transmission. In unacknowledged mode, an RLC transmitter may transmit an RLC protocol data unit (PDU) once, and an RLC receiver may not indicate the reception status of the PDU to the RLC transmitter. In acknowledged mode, each RLC PDU may carry a sequence number (SN) (e.g., a value in a sequence). An RLC receiver may indicate whether a PDU has been successfully received in a status report to the RLC transmitter. The RLC transmitter may retransmit an RLC PDU, if it is determined from a status report that the PDU was not successfully received by the RLC receiver. If the PDU was successfully received, the RLC transmitter may proceed to send the next RLC PDU in the transmission buffer. In some approaches, an RLC transmitter may retransmit an RLC PDU up to N times, where N is a quantity or threshold (e.g., maximum retransmission threshold) configured by a network (e.g., configured via signaling from a network device). Acknowledged mode may be utilized for quality of service (QoS) flows that require relatively higher reliability. However, it may not be efficient to achieve a target reliability via hybrid automatic repeat request (HARQ) alone. Too many retransmissions may result in a loss in throughput or increased delay. Unacknowledged mode may be utilized for QoS flows that demand relatively lower (e.g., average) reliability, low latency, or high throughput. In some approaches, a network may configure one type (e.g., only one type) of RLC mode (e.g., either acknowledged mode or unacknowledged mode) for a data radio bearer (DRB).

In some use cases, mixed modes of transmission may be helpful. Some examples of the techniques described herein may provide one or more RLC transmission modes, in which an RLC entity (e.g., single RLC entity) may transmit some PDUs unacknowledged while others may be delivered with acknowledgment. In an example of extended reality (XR) traffic, some PDUs may demand more reliability than other PDUs within an XR traffic flow (e.g., video). For example, intra-coded frames (I-frames) may have more significance than predicted frames (P-frames), because decoding P-frames may depend on a preceding I-frame. If an I-frame is lost, for instance, then subsequent P-frames encoded based on the I-frame may not be decoded successfully. In some aspects, frames with relatively higher PDU set importance (PSI) levels may be treated with higher reliability (e.g., with acknowledgment). In some cases, XR traffic may have a relatively high bit rate and may demand relatively low latency. Accordingly, a network may not perform too many retransmissions to avoid increasing latency. As latency for video flows may be based on a frame (e.g., a collection of PDUs) instead of individual PDUs, it may be helpful to spend more delay budget on relatively more significant PDUs, while avoiding retransmission for other less significant PDUs. As part of the traffic may avoid retransmission, a total throughput (e.g., for more significant PDUs and/or total non-retransmission traffic) may be increased in some approaches.

In another example, inter-band or frequency range (FR) carrier aggregation (CA) may be performed. Carriers in different bands or FRs may have different characteristics. For example, carriers in frequency division duplexing (FDD) bands may tend to have a relatively wide coverage but relatively narrower carrier bandwidth than carriers in time division duplexing (TDD) bands, which may support relatively higher throughput with relatively less reliability. A similar comparison may be made about carriers in FR1 and FR2. Throughput may be increased (e.g., a reduced total quantity of RLC retransmissions) if most PDUs are sent on relatively high-throughput carriers with an unacknowledged mode and other PDUs are sent with acknowledged mode on more reliable carriers. A relatively high percentage of PDUs may be successfully sent with a single RLC transmission on less reliable carriers. Transmissions on reliable carriers may not demand many retransmissions. The split ratio between different carriers may be configured or determined based on link conditions of different carriers.

Particular aspects of the subject matter described in this disclosure can be implemented to realize one or more of the following potential advantages. In some examples, by controlling an RLC PDU acknowledgment mode (e.g., mixed mode), the described techniques can be used to one or more of increase communication reliability, increase communication throughput, or balance communication reliability with communication throughput.

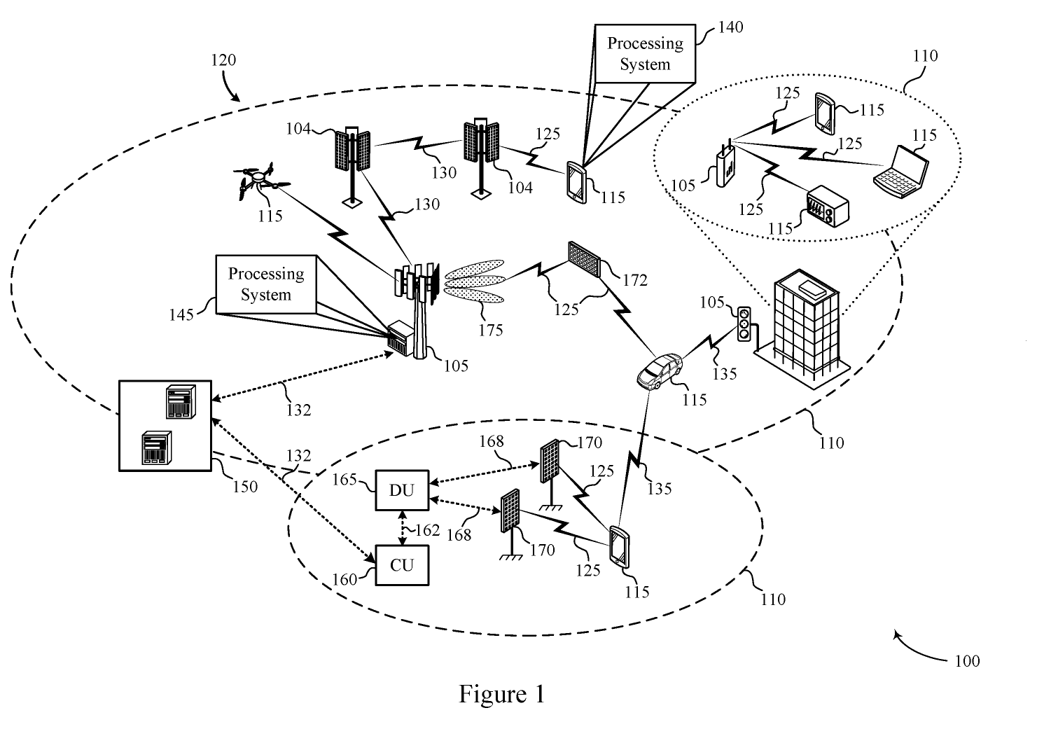

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a packet data convergence protocol (PDCP) layer, or service data adaptation protocol (SDAP) layer may be Internet Protocol (IP)-based. A RLC layer may perform packet segmentation and reassembly to communicate via logical channels. A medium access control (MAC) layer may perform priority handling and multiplexing of logical channels into transport channels. A MAC layer also may implement error detection techniques, error correction techniques, or retransmissions. In a control plane, a radio resource control (RRC) layer may provide establishment, configuration, and maintenance of an RRC connection between UEs 115 and a network entity 105 or a core network 150, supporting radio bearers for user plane data. A physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for acknowledged and non-acknowledged communications. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support increasing throughput, increasing reliability, or balancing throughput with reliability.

Some communications systems may perform retransmissions for increased reliability of packet delivery or may perform communications without retransmissions for increased throughput or reduced latency. In some examples, a communications system may operate in accordance with an acknowledged mode or an unacknowledged mode in RLC transmission. In unacknowledged mode, an RLC transmitter (e.g., a UE 115 or a network entity 105) may transmit an RLC PDU once, and an RLC receiver (e.g., a network entity 105 or a UE 115) may not indicate the reception status of the PDU to the RLC transmitter. In acknowledged mode, each RLC PDU may carry an SN (or a value in a sequence, for instance). An RLC receiver may indicate whether a PDU has been successfully received in a status report to the RLC transmitter. The RLC transmitter may retransmit an RLC PDU, if it is determined from a status report that the PDU was not successfully received by the RLC receiver. If the PDU was successfully received, the RLC transmitter may proceed to send the next RLC PDU in the transmission buffer. In some approaches, an RLC transmitter may retransmit an RLC PDU up to N times, where N is a quantity or threshold (e.g., maximum retransmission threshold) configured by a network (e.g., configured via signaling from a network device). Acknowledged mode may be utilized for QoS flows that require relatively higher reliability. However, it may not be efficient to achieve a target reliability via HARQ alone. Too many retransmissions may result in a loss in throughput or increased delay. Unacknowledged mode may be utilized for QoS flows that demand relatively lower (e.g., average) reliability, low latency, or high throughput. In some approaches, a network may configure one type (e.g., only one type) of RLC mode (e.g., either acknowledged mode or unacknowledged mode) for a DRB.

In some use cases, mixed modes of transmission may be helpful. Some examples of the techniques described herein may provide one or more RLC transmission modes, in which an RLC entity (e.g., single RLC entity) may transmit some PDUs unacknowledged while others may be delivered with acknowledgment. In an example of XR traffic, some PDUs may demand more reliability than other PDUs within an XR traffic flow (e.g., video). For example, I-frames may have more significance than P-frames, because decoding P-frames may depend on a preceding I-frame. If an I-frame is lost, for instance, then subsequent P-frames encoded based on the I-frame may not be decoded successfully. In some aspects, frames with relatively higher PSI levels may be treated with higher reliability (e.g., with acknowledgment). In some cases, XR traffic may have a relatively high bit rate and may demand relatively low latency. Accordingly, a network may not perform too many retransmissions to avoid increasing latency. As latency for video flows may be based on a frame (e.g., a collection of PDUs) instead of individual PDUs, may be helpful to spend more delay budget on relatively more significant PDUs, while avoiding retransmission for other less significant PDUs. As part of the traffic may avoid retransmission, a total throughput may be increased.

In another example, inter-band or FR CA may be performed. Carriers in different bands or FRs may have different characteristics. For example, carriers in FDD bands may tend to have a relatively wide coverage but relatively narrower carrier bandwidth than carriers in TDD bands, which may support relatively higher throughput with relatively less reliability. A similar comparison may be made about carriers in FR1 and FR2. Throughput may be increased (e.g., a total quantity of RLC retransmissions) if most PDUs are sent on relatively high-throughput carriers with an unacknowledged mode and other PDUs are sent with acknowledged mode on more reliable carriers. A relatively high percentage of PDUs may be successfully sent with a single RLC transmission on less reliable carriers. Transmissions on reliable carriers may not demand many retransmissions. The split ratio between different carriers may be configured or determined based on link conditions of different carriers.

Some examples of the techniques described herein may provide one or more retransmission schemes for medium access control-control elements (MAC-CEs) in wireless communication systems (e.g., 6G networks, among other examples), which may help to ensure reliable delivery by configuring retransmission limits, timers, and/or duplication strategies. Some approaches may provide one or more unified RLC transmission techniques that may dynamically select acknowledged or unacknowledged modes for PDUs, with some aspects allowing the transmitter or receiver to make a determination based on one or more rules or packet error rates (PERs). Some approaches may improve network performance via enhanced reliability, enhanced resource allocation, and/or reduced latency. In some cases (e.g., with multi-modality), a DRB may be associated with data transmission with different QoS flows (e.g., intra-DRB QoS flows). In some approaches, it may be helpful for a RLC to be able to dynamically switch between unacknowledged mode and acknowledged mode based on the intra-DRB QoS flows.

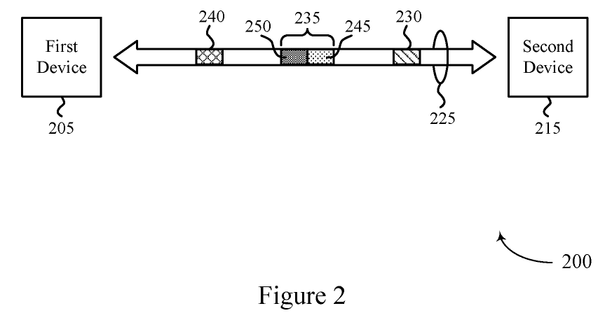

FIG. 2 shows an example of devices 200 that supports acknowledged and non-acknowledged communications. One or more of the devices 200 may be included in the wireless communications system 100 described with reference to FIG. 1. The devices 200 may include a first device 205 and a second device 215. The first device 205 may be an example of a network entity 105, RU 170, DU 165, CU 160, or UE 115 described with reference to FIG. 1, any combination thereof, or another device. The second device 215 may be an example of a network entity 105, RU 170, DU 165, CU 160, or UE 115 described with reference to FIG. 1, any combination thereof, or another device.

The second device 215 may communicate with the first device 205 using a link 225. The link 225 may be an example of a communication link 125, communication link 135, a backhaul link 132, a midhaul link 162, a fronthaul link 168, a wired link, or a wireless link described with reference to FIG. 1, another link (e.g., sidelink, D2D communication link, or V2X link, among other examples), or any combination thereof. The link 225 may include a uni-directional or bi-directional link that enables uplink, downlink, sidelink, other communications, or a combination thereof. For example, the second device 215 may transmit one or more uplink transmissions, such as uplink control signals or uplink data signals, to the first device 205 using the link 225, or the first device 205 may transmit one or more downlink transmissions, such as downlink control signals or downlink data signals, to the second device 215 using the link 225. Additionally, or alternatively, the first device 205 may transmit one or more uplink transmissions, such as uplink control signals or uplink data signals, to the second device 215 using the link 225, or the second device 215 may transmit one or more downlink transmissions, such as downlink control signals or downlink data signals, to the first device 205 using the link 225.

The first device 205 may communicate (e.g., output, transmit, obtain, or receive) configuration information 230 indicating a mixed mode of RLC operation for acknowledged and non-acknowledged (e.g., unacknowledged) PDU communication. The configuration information 230 may be communicated with (e.g., output to, transmitted to, obtained from, or received from) the second device 215. For instance, the first device 205 may output, transmit, obtain, or receive signaling (e.g., RRC signaling, MAC-CE signaling, DCI, UCI, or other signaling) indicating that PDU communication at the RLC layer may be conducted with a mixed mode that may include an acknowledged mode and a non-acknowledged (e.g., unacknowledged) mode. The configuration information 230 may indicate the mixed mode via one or more bits, a code, or an implicit indication, among other examples.

The first device 205 may transmit, or the second device 215 may receive, a set 235 of RLC PDUs based on the mixed mode of RLC operation. In some examples, the set 235 of RLC PDUs may be RLC PDUs corresponding to a traffic flow (e.g., in a single traffic flow), a stream (e.g., in a single stream, a video stream, a data stream, an XR stream, or other stream), a DRB (e.g., a single DRB), a transport block (TB), an RLC entity, or an application (e.g., a single application, such as an XR application, a gaming application, a video application, an audio application, a voice application, or other application), or a source (e.g., a single source or device), among other examples. In some approaches, a set of RLC data units (e.g., DUs or a PDU set) may be a subset of a traffic flow (e.g., a traffic flow may be a video stream within traffic generated by an XR application). Traffic flows with different QoS attributes may be mapped to different QoS flows. Different QoS flows may be mapped to different RLC entities.

A first subset 245 of the set 235 of RLC PDUs may be associated with an acknowledged mode based on the configuration information 230, or a second subset 250 of the set 235 of RLC PDUs may be associated with a non-acknowledged mode based on the configuration information 230. For instance, the first subset 245 may be controlled with acknowledgment, determined with acknowledgment, utilized with acknowledgment, or communicated with acknowledgment. For instance, the second subset 250 may be controlled without acknowledgment, determined without acknowledgment, utilized without acknowledgment, or communicated without acknowledgment. The second subset 250 may be different from the first subset 245 (e.g., may include different RLC PDUs).

In some examples, the first subset 245 of RLC PDUs may include I-frames to be communicated with acknowledgment, and the second subset 245 of RLC PDUs may include P-frames to be communicated without acknowledgment, where the I-frames and the P-frames correspond to the same traffic flow (e.g., video stream). Additionally, or alternatively, the first subset 245 may include one or more RLC PDUs that are scheduled or mapped to a first carrier or first frequency band, and the second subset 245 may include one or more RLC PDUs that are scheduled or mapped to a second carrier or second frequency band. In some approaches, the first carrier or first frequency band may be lower than the second carrier or second frequency band, or the first carrier or first frequency band may be higher than the second carrier or second frequency band. Additionally, or alternatively, the first carrier or first frequency band may be an FDD band and the second carrier or second frequency band may be a TDD band, or the first carrier or first frequency band may be a TDD band and the second carrier or second frequency band may be an FDD band. The first carrier or first frequency band and the second carrier or second frequency band may be aggregated carriers in inter-band CA or FR CA.

In some examples, the transmitter or transmitting device (e.g., the first device 205 or the second device 215) may control or determine (e.g., decide) which PDU(s) are sent with acknowledgment or which PDU(s) are sent without acknowledgment. In some examples, the receiver or receiving device (e.g., the second device 215 or the first device 205) may control or determine (e.g., decide) which PDU(s) are sent with acknowledgment or which PDU(s) are sent without acknowledgment.

In some aspects, the acknowledgment of the first subset 245 or the non-acknowledgment of the second subset 250 may be performed independently from, or in addition to, one or more other acknowledgment schemes, retransmission schemes, or packet loss detection schemes at one or more layers. For instance, the acknowledgment of the first subset 245 or the non-acknowledgment of the second subset 250 may be performed at the RLC layer, while one or more other schemes (e.g., HARQ) may be performed independently at the PHY layer, MAC layer, or PDCP layer, among other examples.

The second device 215 may transmit, or the first device 205 may receive, acknowledgment information 240 for the first subset 245 of the set 235 of RLC PDUs in accordance with the acknowledged mode. For instance, the second device 215 may determine whether one or more RLC PDUs of the first subset 245 were communicated (e.g., transmitted or received) successfully or unsuccessfully. The second device 215 may transmit the acknowledgment information 240 indicate one or more RLC PDUs of the first subset 245 that were communicated successfully or unsuccessfully. In some aspects, the second device 215 may not determine (e.g., at the RLC layer), or the acknowledgment information 240 may not indicate (e.g., at the RLC layer) whether one or more of the RLC PDUs of the second subset 250 were communicated successfully or unsuccessfully.

In some examples, the first subset 245 may include one or more RLC PDUs that are interspersed with one or more RLC PDUs of the second subset 250 (e.g., in time or in frequency). In some aspects, the first subset 245 may include one or more RLC PDUs that are communicated in a block separate from one or more RLC PDUs of the second subset 250 (e.g., in time or in frequency).

In some examples, the acknowledged mode (e.g., AM) or the non-acknowledged mode (e.g., unacknowledged mode (UM)) may be determined or indicated when (e.g., after) a service data unit (SDU) is submitted from the PDCP layer to the RLC layer. For instance, an SDU may be provided to the RLC layer from the PDCP layer for formatting into one or more RLC PDUs. In some approaches, an SDU may be provided to the RLC layer, where an RLC PDU may be formatted to include some of all of the SDU in a payload portion of the RLC PDU. In some aspects, a header or header information may be added to part or all of the SDU to form an RLC PDU. PDU mode control (e.g., acknowledged mode or non-acknowledged mode determination, indication, labeling, or formatting) may be performed at the RLC layer (e.g., on the transmitter, transmitting device, or first device 205, among other examples).

In some aspects, one or more indicators (e.g., a 1-bit indicator, an SN, a code, or an implicit indicator such as formatting, among other examples) may be included in an RLC PDU header to indicate whether the RLC PDU is formatted for acknowledgment (e.g., is included in the first subset 245) or is formatted for non-acknowledgment (e.g., is included in the second subset 250). In some examples, the first subset 245 of the set 235 of RLC PDUs is communicated with one or more SNs and the second subset 250 of the set 235 of RLC PDUs is communicated without an SN. For instance, a PDU to be sent without acknowledgment (e.g., a UM PDU) may not carry any SN in the header of the PDU. A PDU to be sent with acknowledgment (e.g., an AM PDU) may carry a SN in the header of the PDU. The SN may be incremented for each (e.g., after each) PDU with acknowledgment (e.g., AM PDU) that is submitted to the RLC layer. In some approaches, after the transmitter (e.g., first device 205) sends a PDU without acknowledgment (e.g., UM PDU), no further action may be performed by the transmitter for the PDU without acknowledgment at the RLC layer. Additionally, or alternatively, the transmitter (e.g., first device 205) may perform a procedure at the RLC layer for one or more PDUs with acknowledgment (e.g., AM PDUs) after they are sent. For instance, the receiver (e.g., second device 215) may determine whether one or more PDUs with acknowledgment were successfully received and may transmit the acknowledgment information 240 based on the determination. The transmitter (e.g., the first device 205) may perform retransmission of an AM PDU after it is indicated or determined from the acknowledgment information 240 (e.g., a status report from the second device 215) that an AM PDU was not successfully received.

In some examples, an RLC PDU of the set 235 of RLC PDUs may be associated with one of the acknowledged mode or the non-acknowledged mode based on a rule at the RLC layer after an SDU corresponding to the RLC PDU is submitted from a PDCP layer to the RLC layer. For instance, the determination or control (e.g., decision) whether an RLC PDU is associated with the acknowledged more or the non-acknowledged mode may be perform in accordance with one or more established rules.

In some approaches, the rule may include a threshold that is indicated via the configuration information 230. For instance, the first device 205 or the second device 215 may communicate (e.g., output, transmit, obtain, or receive) an indication of a threshold via the configuration information 230.

The RLC PDU of the set 235 of RLC PDUs may be communicated in accordance with one of the acknowledged mode or the non-acknowledged mode based on whether a PSI of the RLC PDU satisfies the threshold. For instance, one or more PDUs (e.g., only PDUs) with a PSI that meets a threshold (e.g., that is greater than or equal to a threshold configured by the network) may be sent with acknowledgment (e.g., may be included in the first subset 245). One or more other PDUs that do not meet the threshold (e.g., that are less than the threshold) may be sent without acknowledgment. In some aspects, the PSI may be determined based on one or more priorities for traffic types. For instance, emergency traffic, voice traffic, XR traffic, internet browsing traffic, email traffic, or background notification traffic, among other examples, may have one or more different priorities that may be utilized to map PSIs to RLC PDUs. A PSI may be assigned to an RLC PDU (e.g., may be indicated in a header of an RLC PDU) based on traffic type.

In some approaches, the rule may be based on a PDU type condition. The RLC PDU of the set 235 of RLC PDUs may be communicated in accordance with one of the acknowledged mode or the non-acknowledged mode based on whether a type of the RLC PDU satisfies the PDU type condition. For instance, a PDU type may refer to whether the PDU comprises control information or payload information. In some aspects, one or more types (e.g., selected types) of PDUs may be sent with acknowledgment (e.g., may be included in the first subset 245), while one or other types of the PDUs may be set without acknowledgment (e.g., may be included in the second subset 250). For example, control packets or packets including TCP ACK information may be sent with acknowledgment, while one or more other types of packets may be sent without acknowledgment.

In some approaches, whether an RLC PDU is acknowledged or non-acknowledged (e.g., whether an RLC PDU is included in the first subset 245 or the second subset 250) may be based on a probability (e.g., probability p). In some aspects, the first device 205 may generate a random quantity (e.g., at the PDCP layer or at the RLC layer). The rule may be based on the probability, and the RLC PDU of the set 235 of RLC PDUs may be communicated in accordance with one of the acknowledged mode or the non-acknowledged mode based on a comparison of the probability and the random quantity. For instance, when (e.g., before, during, or after) an SDU is sent to the RLC layer, the PDCP layer or the RLC layer may draw a random number from a uniform distribution over the interval of (0, 1). If the random number is less than p, then the SDU or RLC PDU may be sent with acknowledgment. Otherwise, the SDU or RLC PDU may be sent without acknowledgment.

In some examples, the probability may be indicated via the configuration information 230. The first device 205 or the second device 215 may communicate (e.g., output, transmit, obtain, or receive) the indication of the probability. For instance, the probability p may be configured by the network (e.g., a network entity).

In some approaches, a range of probabilities may be indicated via the configuration information 230. For example, the probability p may be adapted (e.g., determined or selected by the first device 205) within a range configured by the network based on one or more respective PERs of acknowledged PDUs (e.g., AM PDUs) and non-acknowledged PDUs (e.g., UM PDUs). A PER may include or indicate one or more statistics related to a percentage of PDUs that have failed or that have been received unsuccessfully. Additionally, or alternatively, the first device 205 (e.g., transmitter, UE, network entity, or another device) may apply a procedure (e.g., formula, adaptive operation, or AI/ML algorithm, among other examples) to determine the probability p.

In some aspects, communicating (e.g., outputting, transmitting, obtaining, or receiving) the set 235 of RLC PDUs may include transmitting a first RLC PDU of the set 235 of RLC PDUs with an SN and a second RLC PDU of the set 235 of RLC PDUs without an SN. Communicating (e.g., outputting, transmitting, obtaining, or receiving) the acknowledgment information 240 may include communicating acknowledgment or negative acknowledgment (ACK/NACK) information corresponding to the first RLC PDU. Regarding receiver (e.g., second device 215) behavior, for example, when (e.g., after) the receiver receives a PDU without an SN, the receiver (e.g., RLC layer) may submit the PDU to a higher layer (e.g., PDCP). The RLC layer may not perform additional actions (e.g., acknowledgment, detection of unsuccessfully received PDUs, or retransmission, among other examples) for unacknowledged RLC PDUs. For PDUs with acknowledgment (e.g., SNs), the receiver may perform one or more procedures for (e.g., acknowledgment, detection of unsuccessfully received PDUs, or retransmission, among other examples). For example, the receiver (e.g., second device 215) may include an ACK/NACK for the PDU in the acknowledgment information 240 (e.g., status report).

In some examples, the second device 215 may transmit, or the first device 205 may receive, an indication of a quantity of received RLC PDUs of the second subset 250. A first quantity of acknowledged PDUs or a second quantity of non-acknowledged RLC PDUs may be based on a probability corresponding to a PER of the quantity of received RLC PDUs. In some aspects, for instance, the receiver (e.g., second device 215) may perform one or more operations when adaptation between the acknowledged mode and the non-acknowledged mode is enabled or performed (e.g., for approaches that utilize the probability p). For example, the receiver (e.g., second device 215) may measure a PER and indicate (e.g., report) the PER to the transmitter (e.g., first device 205). Additionally, or alternatively, the receiver (e.g., second device 215) may periodically indicate (e.g., report), to the transmitter (e.g., first device 205), a quantity of non-acknowledged PDUs (e.g., UM PDU) that the receiver has received (since a previous report or since an RLC entity was established, for example). The indication or report may enable the transmitter to compare the number of PDUs sent and received to determine the PER. The PER may be utilized (by the first device 205 or the second device 215) to control or adapt whether one or more PDUs (e.g., a proportion of RLC PDUs) are acknowledged or non-acknowledged (e.g., may be utilized to switch between acknowledged mode and non-acknowledged mode for one or more RLC PDUs). In some examples, the adaptation of p may be controlled based on the PER, where p may be set, increased, or decreased based on the PER (e.g., where p may be controlled in a direct or inverse relationship with the PER, may be increased or decreased in response to the PER meeting or crossing a threshold, or may be set in response to the PER being within a range). For example, an increased PER may lead to an increased quantity or proportion of RLC PDUs being formatted or communicated with acknowledgment.

In some approaches, the transmitter (e.g., the first device 205) may not determine or control whether a PDU is acknowledged or non-acknowledged. The first subset 245 of the set 235 of RLC PDUs and the second subset 250 of the set 235 of RLC PDUs may be communicated (e.g., transmitted to the second device 215) with SNs. The second device 215 may determine or control which RLC PDUs to acknowledge (e.g., may determine or control which RLC PDUs are included in the first subset 245 and the second subset 250). The second device 215 may transmit, or the first device 205 may receive, ACK/NACK (e.g., a status report) for one or more RLC PDUs of the first subset 245 of the set 235 of RLC PDUs. In some aspects, ACK/NACK may not be communicated (e.g., output, transmitted, obtained, or received) for the second subset 250 of the set 235 of RLC PDUs, regardless of whether any RLC PDU of the second subset 250 was received successfully or unsuccessfully. The first device 205 may transmit (e.g., retransmit), or the second device may receive, one or more RLC PDUs of the first subset 245 of the set 235 of RLC PDUs. In some examples, the first device 305 may include an SN in the header of one or more (e.g., each or every RLC PDU) that is sent. After receiving a status report from the receiver (e.g., second device 215), the transmitter (e.g., first device 205) may determine which PDUs were not successfully received. The transmitter may then performs retransmission of those PDUs.

In some examples, the transmitter (e.g., first device 205) may include a type indicator in the header of one or more PDUs (e.g., each PDU). The value of the type indicator may be selected based on one or more factors (e.g., a PSI of an RLC PDU or a type of an RLC PDU). For instance, the type indicator may indicate whether an RLC PDU contains TCP ACK/NACK information or TCP data.

In some approaches, the receiver (e.g., second device 215) may perform one or more operations or utilize one or more mechanisms to determine whether an RLC PDU communication has failed. For instance, one or more operations for triggering, transmission, or formatting of the acknowledgment information 240 (e.g., status report) may be performed by the receiver (e.g., second device 215). When a gap occurs in the SNs of received RLC PDUs, for example, the receiver (e.g., second device 215) may start or initiate a timer. When the timer expires, the receiver may determine that the RLC PDU with the lowest SN in the gap has failed or been unsuccessfully received.

In some examples, the second device 215 may generate or send an ACK for all RLC PDUs in the second subset 245, regardless of whether an RLC PDU in the second subset 245 was successfully received (e.g., may send correct NACKs only for unsuccessfully received RLC PDUs in the first subset 245, but not for unsuccessfully received RLC PDUs in the second subset 250). For instance, the second device 215 may transmit, or the first device 205 may receive, a NACK for a subset of unsuccessfully received RLC PDUs. The subset of unsuccessfully received RLC PDUs may be based on a response probability associated with the set 235 of RLC PDUs. For instance, the receiver (e.g., the second device 215) may determine whether to request retransmission of a failed PDU. The determination (e.g., decision) of whether to request retransmission of the failed PDU may be based on a response probability pᵣ. In some aspects, the receiver (e.g., the second device 215) may generate or draw a random value from a uniform distribution over the interval (0, 1). If the value is less than pᵣ (e.g., if the RLC PDU is included in the second subset 245), the second device 215 may send acknowledgment information 240 (e.g., an ACK) for the RLC PDU even if the RLC PDU has not been successfully received (e.g., may send an ACK in a status report for the RLC PDU). If the value is greater than or equal to pᵣ (e.g., if the RLC PDU is included in the first subset 245), the receiver (e.g., second device 215) may send a NACK for the RLC PDU in the acknowledgment information 240 (e.g., in the status report).

In some approaches, the response probability pᵣ may be indicated via the configuration information 230. For instance, the first device 205 may indicate the response probability pᵣ via the configuration information 230. For instance, the response probability pᵣ may be configured by the network (e.g., via control signaling).

In some aspects, the response probability pᵣ may be from a range of response probabilities. The range of response probabilities may be indicated via the configuration information 230. For example, the response probability pᵣ may be adapted (e.g., determined or selected by the second device 215) within a range configured by the network. In some approaches, the adaptation may be based on a measurement (at the receiver or second device 215, for instance) of PER. For instance, the adaptation may be controlled based on the PER, where pᵣ may be set, increased, or decreased based on the PER (e.g., where pᵣ may be controlled in a direct or inverse relationship with the PER, may be increased or decreased in response to the PER meeting or crossing a threshold, or may be set in response to the PER being within a range). Additionally, or alternatively, the second device 215 (e.g., receiver, UE, network entity, or another device) may apply a procedure (e.g., formula, adaptive operation, or AI/ML algorithm, among other examples) to determine the response probability pᵣ. In some examples, the response probability pᵣ may be equal to, similar to, or different from the probability p.

Some examples of the techniques described herein may enable different modes via configuration. When a network (e.g., network entity, first device 205, or second device 215, among other examples) establishes a DRB, the network may select a mode (e.g., acknowledged mode, a non-acknowledged mode, or a mixed mode of acknowledged mode and non-acknowledged mode) for use by the DRB via one or more configuration parameters (e.g., a probability p, a probability pᵣ, or another value). In some approaches, the configuration information 230 may indicate a probability of an RLC PDU of the set 235 of RLC PDUs being an acknowledged RLC PDU or a non-acknowledged RLC PDU. For instance, a probability (e.g., p or pᵣ) of 0 may indicate a non-acknowledged mode where all RLC PDUs are non-acknowledged (e.g., where the first subset 245 is empty and the second subset 250 includes all RLC PDUs in the set 235). A probability (e.g., p or pᵣ) of 1 may indicate an acknowledged mode where all RLC PDUs are acknowledged (e.g., where the first subset 245 includes all RLC PDUs in the set 235 and the second subset 250 is empty). For instance, if the network sets p or pᵣ to 1, then all PDUs may be sent with the AM. If the network sets p or pᵣ to 0, then all PDUs may sent with UM. A probability (e.g., p or pᵣ) of between 0 and 1 may indicate a mixed mode of an acknowledged mode and a non-acknowledged mode, where the proportion of RLC PDUs that are acknowledged versus non-acknowledged corresponds to the probability (e.g., a probability of 0.5 may result in the first subset 245 including half of the RLC PDUs in the set 235 and the second subset 250 including half of the RLC PDUs).

In some approaches another value or parameter (e.g., a threshold) may be utilized to control the mode. For example, if the network sets a threshold to a lowest level (e.g., a lowest importance level), then all PDUs may be sent with AM. If the threshold is set to a highest level (e.g., a highest importance level), then all PDUs may be sent with UM. A threshold between the lowest and highest level may result in a mixed mode. Setting the threshold may be utilized in conjunction with one or more of the techniques or approaches described herein.

In some examples, the first device 205 or the second device 215 may communicate (e.g., output, transmit, obtain, or receive) capability information indicating a capability to communicate with the mixed mode of operation for acknowledged and non-acknowledged RLC PDU communication. The configuration information 230 may be communicated based on (e.g., in accordance with) the capability information.

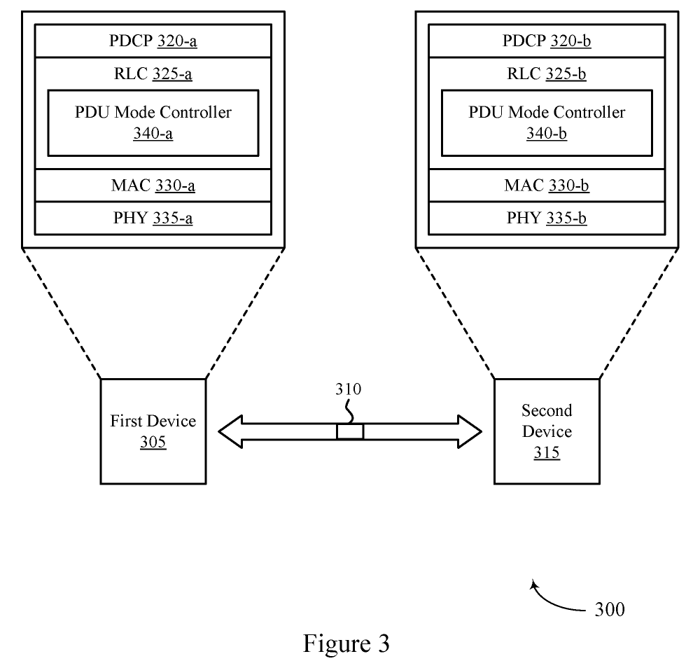

FIG. 3 shows an example of devices 300 that supports acknowledged and non-acknowledged communications. The devices 300 include a first device 305, which may be an example of a network entity 105, a UE 115, a transmitter, a transmitting device, or a first device 205 as described with reference to FIGS. 1 or 2. The devices 300 also include a second device 315, which may be an example of a UE 115, a network entity 105, a receiver, a receiving device, or a second device 215 described with reference to FIGS. 1 or 2. The first device 305 may include a PDCP layer 320-a, an RLC layer 325-a, a MAC layer 330-a, and a PHY layer 335-a. The second device 315 may include a PDCP layer 320-b, an RLC layer 325-b, a MAC layer 330-b, and a PHY layer 335-b. The devices 300 may implement aspects of wireless communications system 100 or of the devices 200. For example, the devices 300 may support techniques for acknowledged and non-acknowledged communications (e.g., unified approaches for RLC communication) between the first device 305 and the second device 315.

The first device 305 may generate a data unit 310 at the PDCP layer 320-a or the RLC layer 325-a. At the PDCP layer 320-a, the data unit 310 may be an SDU. The data unit 310 (e.g., SDU) may be provided (e.g., sent, passed, communicated) from the PDCP layer 320-a to the RLC layer 325-a.

In some examples, the RLC layer 325-a may include a PDU mode controller 340-a. For instance, in implementations where the first device 305 (e.g., transmitting device) controls the PDU mode (e.g., acknowledged mode, non-acknowledged mode, or mixed mode), the RLC layer 325-a may include the PDU mode controller 340-a. One or more of the operations or techniques described with reference to FIG. 2 may be performed by the PDU mode controller 340-a. For instance, the PDU mode controller 340-a may control or determine whether the data unit 310 (e.g., RLC PDU) is formatted or communicated in association with an acknowledged mode, a non-acknowledged mode, or a mixed mode. For instance, the PDCP layer 320-a or the RLC layer 325-a may generate a random quantity. In approaches where the PDCP layer 320-a generates the random quantity, the random quantity may be provided (e.g., passed or communicated) to the RLC layer 325-a from the PDCP layer 320-a. The PDU mode controller 340-a may compare the random quantity with a threshold (e.g., probability) to determine whether the data unit 310 is to be formatted and communicated with acknowledgment or without acknowledgment. In another example, the PDU mode controller 340-a may format the data unit 310 based on a PSI of the data unit 310 or a PDU type of the data unit 310. In some approaches, the PDU mode controller 340-a may add (e.g., selectively add) information (e.g., header information) to one or more RLC PDUs. For instance, the PDU mode controller 340-a may selectively add an indicator (e.g., a bit or SN) of the mode (e.g., acknowledged mode, non-acknowledged mode, or mixed mode) to one or more RLC PDUs (e.g., the data unit 310). In some approaches, the PDU mode controller 340-a may add a type indicator to the data unit 310 to facilitate receiver-side PDU mode control. One or more of the techniques described with reference to FIG. 2 may be performed by the PDU mode controller 340-a. For instance, the PDU mode controller 340-a may execute or implement one or more of the rules, techniques, approaches, aspects, or examples described with reference to FIG. 2.

In some approaches, the first device 305 may receive an indication of a PER or a quantity of received RLC PDUs (e.g., successfully received or unsuccessfully received PDUs) at the second device 315. The first device 305 (e.g., PDU mode controller 340-a) may adapt one or more rules, parameters, quantities, or values. For instance, the PDU mode controller 340-a may increase or decrease a threshold (e.g., probability) or change (e.g., add, remove, or modify) one or more rules or conditions for determining whether a data unit 310 is acknowledged or non-acknowledged (e.g., based on the PER).

The data unit 310 may be passed to the MAC layer 330-a or to the PHY layer 335-a for transmission. When the data unit 310 is received by the second device 315, the data unit 310 may be passed to the PHY layer 335-b, to the MAC layer 330-b, and to the RLC layer 325-b. The data unit 310 may be passed to the PDCP layer 320-b from the RLC layer 325-b. In some examples, if the data unit 310 is unacknowledged, the data unit 310 may be passed to the PDCP layer 320-b (e.g., without missing packet detection at the RLC layer 325-b). In some approaches, the RLC layer 325-b may detect with an RLC PDU (e.g., the data unit 310) was received successfully or not based on one or more SNs (e.g., if an SN is skipped or missing).

In some examples, the RLC layer 325-b may include a PDU mode controller 340-b. For instance, in implementations where the second device 315 (e.g., receive device) controls the PDU mode (e.g., acknowledged mode, non-acknowledged mode, or mixed mode), the RLC layer 325-b may include the PDU mode controller 340-b. One or more of the operations or techniques described with reference to FIG. 2 may be performed by the PDU mode controller 340-b. For instance, the PDU mode controller 340-b may control or determine whether acknowledgment or non-acknowledgment is performed for the data unit 310 (e.g., RLC PDU). In some examples, all RLC PDUs may be communicated from the first device 305 with an SN, and the PDU mode controller 340-b may select one or more of the RLC PDUs for acknowledgment or non-acknowledgment (independent of whether the RLC PDUs were received successfully or not, for instance). In some examples, the PDU mode controller 340-b may determine whether to acknowledge the data unit 310 based on a type indicator of the data unit 310 (e.g., in the PDU header of the data unit 310). Additionally, or alternatively, the PDU mode controller 340-b may determine, based on a response probability pᵣ, whether the data unit 310 is acknowledged or non-acknowledged. For instance, the PDU mode controller 340-b may generate a random quantity and may compare the random quantity with a threshold (e.g., response probability pᵣ) to determine whether the data unit 310 is to be acknowledged or non-acknowledged. For one or more RLC PDUs that are acknowledged, the second device 315 may transmit ACK/NACK information to the first device 305 (e.g., for retransmission in the case of a NACK). One or more of the techniques described with reference to FIG. 2 may be performed by the PDU mode controller 340-b. For instance, the PDU mode controller 340-b may execute or implement one or more of the rules, techniques, approaches, aspects, or examples described with reference to FIG. 2.

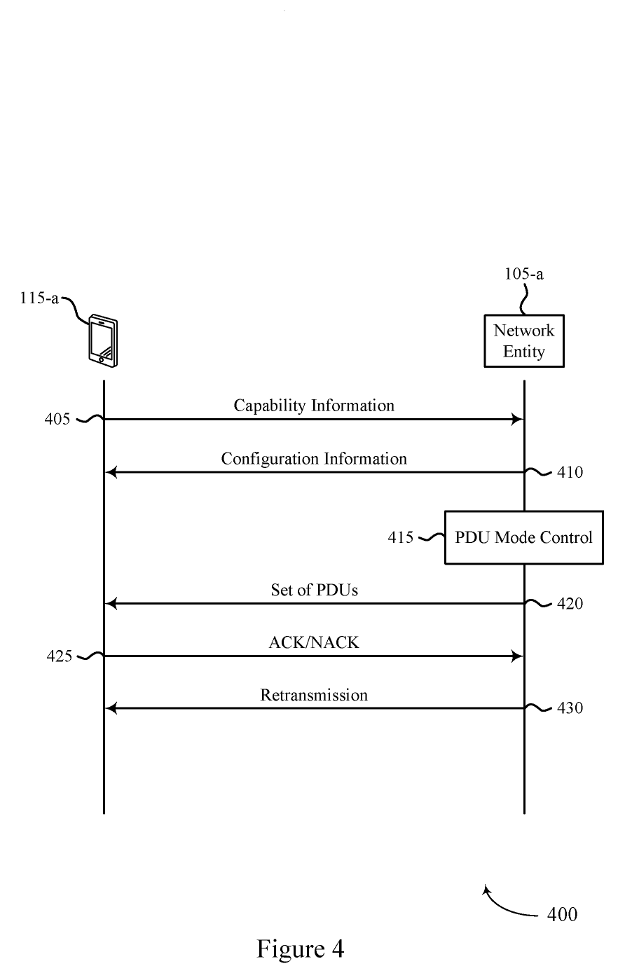

FIG. 4 shows an example of a process flow 400 that supports acknowledged and non-acknowledged communications. The process flow 400 may include a UE 115-a, which may be an example of the UE 115, the first device 205, the second device 215, the first device 305, or the second device 315 described with reference to FIGS. 1, 2 or 3. The process flow 400 may also include a network entity 105-a, which may be an example of the network entity 105, the first device 205, the second device 215, the first device 305, or the second device 315 described with reference to FIGS. 1, 2 or 3.

In the following description of the process flow 400, the communications between the UE 115-a and the network entity 105-a may be transmitted in the example order shown or in a different order than the example order shown. Additionally, or alternatively, the operations performed by the UE 115-a or the network entity 105-a may be performed in the order shown or in different orders or at different times. One or more operations may be omitted from the process flow 400, or one or more other operations may be added to the process flow 400. Although some operations or signaling may be shown to occur at different times for discussion purposes, these operations may actually occur at the same time or in overlapping time periods in some examples.

At 405, the UE 115-a may output (e.g., transmit), or the network entity 105-a may obtain (e.g., receive), capability information. For instance, the capability information may be communicated as described with reference to FIG. 2.

At 410, the network entity 105-a may output (e.g., transmit), or the UE 115-a may obtain (e.g., receive), configuration information. For instance, the network entity 105-a may transmit the configuration information as described with reference to FIG. 2.

At 415, the network entity 105-a may perform PDU mode control. For instance, the network entity 105-a may perform PDU mode control (e.g., determine whether one or more RLC PDUs are to be formatted or communicated with acknowledgment or non-acknowledgment as described with reference to FIG. 2 or FIG. 3.

At 420, the network entity 105-a may output (e.g., transmit), or the UE 115-a may obtain (e.g., receive), a set of PDUs (e.g., RLC PDUs). For instance, the network entity 105-a may transmit the set of PDUs as described with reference to FIGS. 2 or 3.

At 425, the UE 115-a may output (e.g., transmit), or the network entity 105-a may obtain (e.g., receive), ACK/NACK. For instance, acknowledgment information (e.g., ACK/NACK) may be communicated for one or more RLC PDUs as described with reference to FIGS. 2 or 3.

At 430, the network entity 105-a may output (e.g., transmit), or the UE 115-a may obtain (e.g., receive), one or more retransmissions. For instance, the network entity 105-a may retransmit one or more RLC PDUs for one or more NACKs as described with reference to FIGS. 2 or 3.

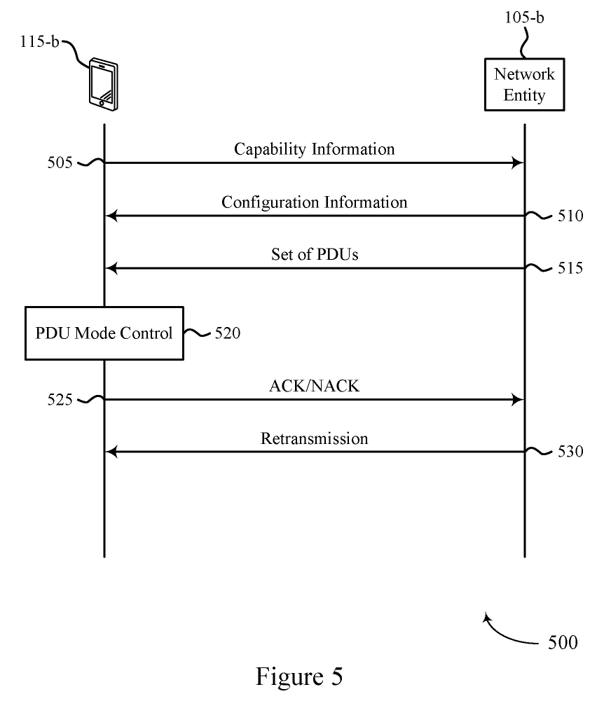

FIG. 5 shows an example of a process flow 500 that supports acknowledged and non-acknowledged communications. The process flow 500 may include a UE 115-b, which may be an example of the UE 115, the first device 205, the second device 215, the first device 305, or the second device 315 described with reference to FIGS. 1, 2 or 3. The process flow 500 may also include a network entity 105-b, which may be an example of the network entity 105, the first device 205, the second device 215, the first device 305, or the second device 315 described with reference to FIGS. 1, 2 or 3.

In the following description of the process flow 500, the communications between the UE 115-b and the network entity 105-b may be transmitted in the example order shown or in a different order than the example order shown. Additionally, or alternatively, the operations performed by the UE 115-b or the network entity 105-b may be performed in the order shown or in different orders or at different times. One or more operations may be omitted from the process flow 500, or one or more other operations may be added to the process flow 500. Although some operations or signaling may be shown to occur at different times for discussion purposes, these operations may actually occur at the same time or in overlapping time periods in some examples.

At 505, the UE 115-b may output (e.g., transmit), or the network entity 105-b may obtain (e.g., receive), capability information. For instance, the capability information may be communicated as described with reference to FIG. 2.

At 510, the network entity 105-b may output (e.g., transmit), or the UE 115-b may obtain (e.g., receive), configuration information. For instance, the network entity 105-b may transmit the configuration information as described with reference to FIG. 2.

At 515, the network entity 105-b may output (e.g., transmit), or the UE 115-b may obtain (e.g., receive), a set of PDUs (e.g., RLC PDUs). For instance, the network entity 105-b may transmit the set of PDUs as described with reference to FIGS. 2 or 3.

At 520, the UE 115-b may perform PDU mode control. For instance, the UE 115-b may perform PDU mode control (e.g., determine whether one or more RLC PDUs are to be acknowledged or non-acknowledged (e.g., whether to transmit ACK/NACK for one or more RLC PDUs independent of whether the RLC PDUs were successfully or unsuccessfully received) as described with reference to FIGS. 2 or 3.

At 525, the UE 115-b may output (e.g., transmit), or the network entity 105-b may obtain (e.g., receive), ACK/NACK. For instance, acknowledgment information (e.g., ACK/NACK) may be communicated for one or more RLC PDUs as described with reference to FIGS. 2 or 3.

At 530, the network entity 105-b may output (e.g., transmit), or the UE 115-b may obtain (e.g., receive), one or more retransmissions. For instance, the network entity 105-b may retransmit one or more RLC PDUs for one or more NACKs as described with reference to FIGS. 2 or 3.

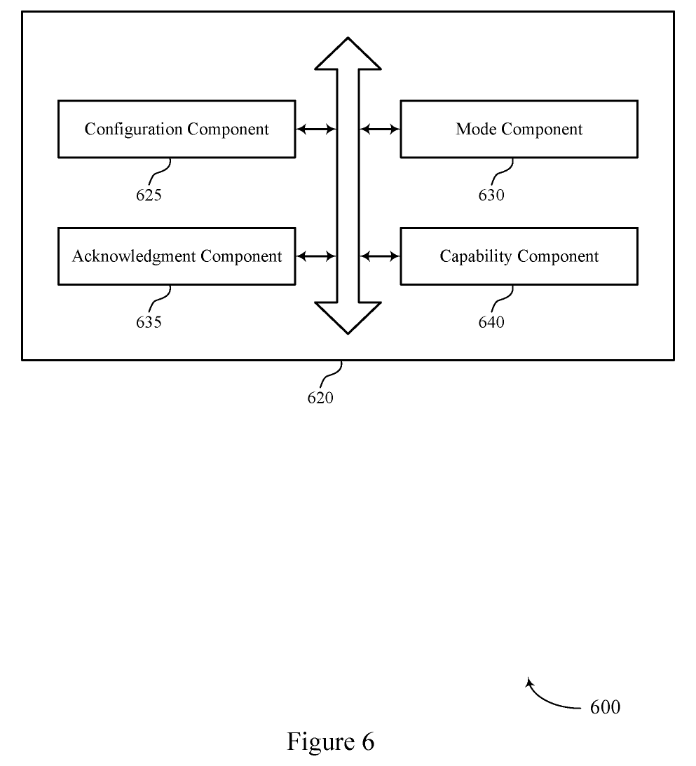

FIG. 6 shows a block diagram 600 of a processing system 620 that supports acknowledged and non-acknowledged communications in accordance with one or more aspects of the present disclosure. The processing system 620 may be an example of aspects of a processing system 140 or a processing system 145, as described herein. The processing system 620, or various components thereof, may be an example of means for performing (e.g., to cause the processing system 620 to perform) various aspects of acknowledged and non-acknowledged communications as described herein. For example, the processing system 620 may include a configuration component 625, a mode component 630, an acknowledgment component 635, a capability component 640, or any combination thereof. Each of these components, or components or subcomponents thereof (e.g., one or more processors, one or more memories), may communicate, directly or indirectly, with one another (e.g., via one or more buses).

The configuration component 625 is capable of, configured to, or operable to support a means for communicating configuration information indicating a mixed mode of RLC operation for acknowledged and non-acknowledged PDU communication. The mode component 630 is capable of, configured to, or operable to support a means for transmitting a set of RLC PDUs based on the mixed mode of RLC operation, where a first subset of the set of RLC PDUs is associated with an acknowledged mode based on the configuration information and a second subset of the set of RLC PDUs is associated with a non-acknowledged mode based on the configuration information, and where the second subset is different from the first subset. The acknowledgment component 635 is capable of, configured to, or operable to support a means for receiving acknowledgment information for the first subset of the set of RLC PDUs in accordance with the acknowledged mode.

In some examples, transmitting the set of RLC PDUs includes transmitting a first RLC PDU of the set of RLC PDUs with a sequence number and a second RLC PDU of the set of RLC PDUs without a sequence number. In some examples, receiving the acknowledgment information includes receiving ACK/NACK information corresponding to the first RLC PDU.

In some examples, the mode component 630 is capable of, configured to, or operable to support a means for receiving an indication of a quantity of received RLC PDUs of the second subset, where a first quantity of acknowledged PDUs and a second quantity of non-acknowledged RLC PDUs are based on a probability corresponding to a PER of the quantity of received RLC PDUs.

In some examples, the acknowledgment component 635 is capable of, configured to, or operable to support a means for receiving a negative acknowledgment (NACK) for one or more RLC PDUs of the first subset of the set of RLC PDUs. In some examples, the acknowledgment component 635 is capable of, configured to, or operable to support a means for transmitting the one or more RLC PDUs of the first subset of the set of RLC PDUs.

In some examples, the acknowledgment component 635 is capable of, configured to, or operable to support a means for receiving a NACK for a subset of unsuccessfully received RLC PDUs, where the subset of unsuccessfully received RLC PDUs is based on a response probability associated with the set of RLC PDUs.

In some examples, the response probability is indicated via the configuration information.

In some examples, the response probability is from a range of response probabilities. In some examples, the range of response probabilities is indicated via the configuration information.

In some examples, an RLC PDU of the set of RLC PDUs is associated with one of the acknowledged mode or the non-acknowledged mode based on a rule at an RLC layer after a SDU corresponding to the RLC PDU is submitted from a PDCP layer to the RLC layer.

In some examples, the rule includes a threshold that is indicated via the configuration information, and the RLC PDU of the set of RLC PDUs is communicated in accordance with one of the acknowledged mode or the non-acknowledged mode based on whether a PDU set importance (PSI) of the RLC PDU satisfies the threshold.

In some examples, the rule is based on a PDU type condition, and the RLC PDU of the set of RLC PDUs is communicated in accordance with one of the acknowledged mode or the non-acknowledged mode based on whether a type of the RLC PDU satisfies the PDU type condition.

In some examples, the mode component 630 is capable of, configured to, or operable to support a means for generating a random quantity, where the rule is based on a probability, and the RLC PDU of the set of RLC PDUs is communicated in accordance with one of the acknowledged mode or the non-acknowledged mode based on a comparison of the probability and the random quantity.

In some examples, the probability is indicated via the configuration information.

In some examples, a range of probabilities is indicated via the configuration information.

In some examples, the first subset of the set of RLC PDUs is communicated with one or more sequence numbers and the second subset of the set of RLC PDUs is communicated without a sequence number.

In some examples, the configuration information indicates a probability of an RLC PDU of the set of RLC PDUs being an acknowledged RLC PDU or a non-acknowledged RLC PDU.

In some examples, the capability component 640 is capable of, configured to, or operable to support a means for communicating capability information indicating a capability to communicate with the mixed mode of operation for acknowledged and non-acknowledged RLC PDU communication, where the configuration information is transmitted based on the capability information.

In some examples, the configuration component 625 is capable of, configured to, or operable to support a means for communicating configuration information indicating a mixed mode of RLC operation for acknowledged and non-acknowledged PDU communication. In some examples, the mode component 630 is capable of, configured to, or operable to support a means for receiving a set of RLC PDUs based on the mixed mode of RLC operation, where a first subset of the set of RLC PDUs is associated with an acknowledged mode based on the configuration information and a second subset of the set of RLC PDUs is associated with a non-acknowledged mode based on the configuration information, and where the second subset is different from the first subset. In some examples, the acknowledgment component 635 is capable of, configured to, or operable to support a means for transmitting acknowledgment information for the first subset of the set of RLC PDUs in accordance with the acknowledged mode.

In some examples, receiving the set of RLC PDUs includes receiving a first RLC PDU of the set of RLC PDUs with a sequence number and a second RLC PDU of the set of RLC PDUs without a sequence number. In some examples, transmitting the acknowledgment information includes transmitting ACK/NACK information corresponding to the first RLC PDU.

In some examples, the mode component 630 is capable of, configured to, or operable to support a means for transmitting an indication of a quantity of received RLC PDUs of the second subset, where a first quantity of acknowledged PDUs and a second quantity of non-acknowledged RLC PDUs are based on a probability corresponding to a PER of the quantity of received RLC PDUs.

In some examples, the acknowledgment component 635 is capable of, configured to, or operable to support a means for transmitting a NACK for a subset of unsuccessfully received RLC PDUs, where the subset of unsuccessfully received RLC PDUs is based on a response probability associated with the set of RLC PDUs.

In some examples, the response probability is indicated via the configuration information.

In some examples, the response probability is from a range of response probabilities. In some examples, the range of response probabilities is indicated via the configuration information.

In some examples, an RLC PDU of the set of RLC PDUs is associated with one of the acknowledged mode or the non-acknowledged mode based on a rule at an RLC layer after a SDU corresponding to the RLC PDU is submitted from a PDCP layer to the RLC layer.

In some examples, the first subset of the set of RLC PDUs is communicated with one or more sequence numbers and the second subset of the set of RLC PDUs is communicated without a sequence number.

In some examples, the configuration information indicates a probability of an RLC PDU of the set of RLC PDUs being an acknowledged RLC PDU or a non-acknowledged RLC PDU.

In some examples, the capability component 640 is capable of, configured to, or operable to support a means for communicating capability information indicating a capability to communicate with the mixed mode of operation for acknowledged and non-acknowledged RLC PDU communication, where the configuration information is transmitted based on the capability information.

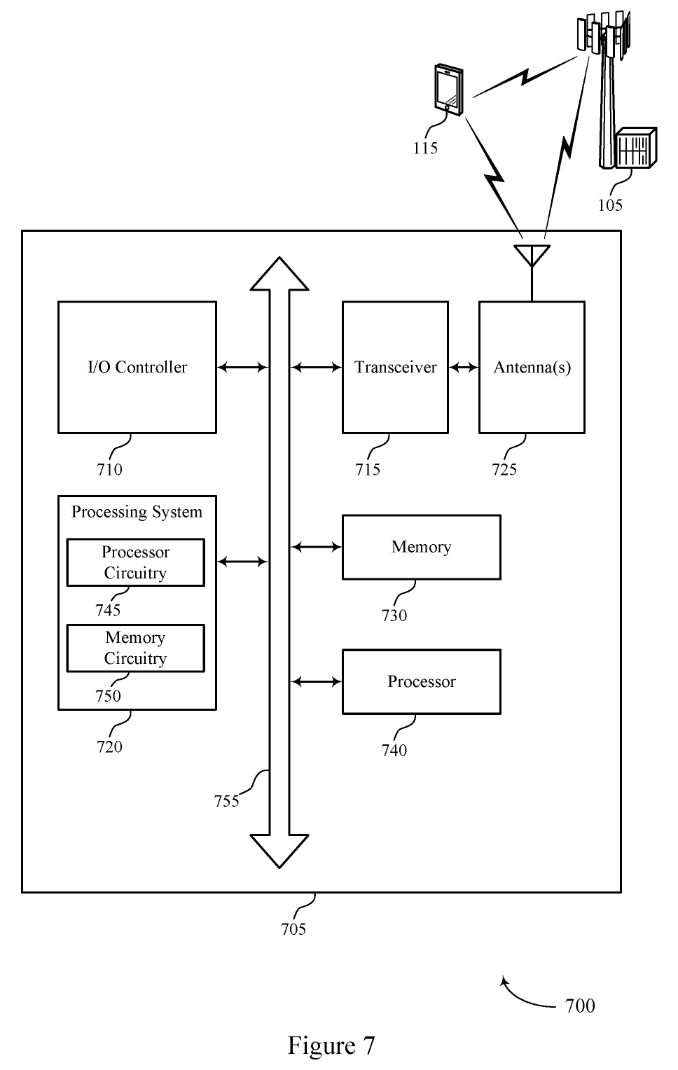

FIG. 7 shows an example of a system 700 including a device 705 that supports acknowledged and non-acknowledged communications. The device 705 may be an example of or include components of a first device 205, a second device 215, a first device 305, a second device 315, or another device as described herein. The device 705 may include a processing system 720, an I/O controller, such as an I/O controller 710, a transceiver 715, one or more antennas 725, at least one memory 730, at least one processor 740, a processor circuitry 745, and a memory circuitry 750. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740 (e.g., directly, indirectly, without pre-processing, after pre-processing), cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

For example, the processing system 720 is capable of, configured to, or operable to support a means for communicating configuration information indicating a mixed mode of RLC operation for acknowledged and non-acknowledged PDU communication. The processing system 720 is capable of, configured to, or operable to support a means for transmitting a set of RLC PDUs based on the mixed mode of RLC operation, where a first subset of the set of RLC PDUs is associated with an acknowledged mode based on the configuration information and a second subset of the set of RLC PDUs is associated with a non-acknowledged mode based on the configuration information, and where the second subset is different from the first subset. The processing system 720 is capable of, configured to, or operable to support a means for receiving acknowledgment information for the first subset of the set of RLC PDUs in accordance with the acknowledged mode.

For example, the processing system 720 is capable of, configured to, or operable to support a means for communicating configuration information indicating a mixed mode of RLC operation for acknowledged and non-acknowledged PDU communication. The processing system 720 is capable of, configured to, or operable to support a means for receiving a set of RLC PDUs based on the mixed mode of RLC operation, where a first subset of the set of RLC PDUs is associated with an acknowledged mode based on the configuration information and a second subset of the set of RLC PDUs is associated with a non-acknowledged mode based on the configuration information, and where the second subset is different from the first subset. The processing system 720 is capable of, configured to, or operable to support a means for transmitting acknowledgment information for the first subset of the set of RLC PDUs in accordance with the acknowledged mode.

By including or configuring the processing system 720 for operation in the device 705 as described herein, may support techniques for improved communication reliability, reduced latency, reduced power consumption, more efficient utilization of communication resources, improved coordination between devices, longer battery life, or improved utilization of processing capability.

The processing system 720 may be an example of a processing system 140 or a processing system 620. For example, the processing system 720 may include processor circuitry 745 and memory circuitry 750 that stores code, and may be configured to cause the device 705 to perform operations that support acknowledged and non-acknowledged communications. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

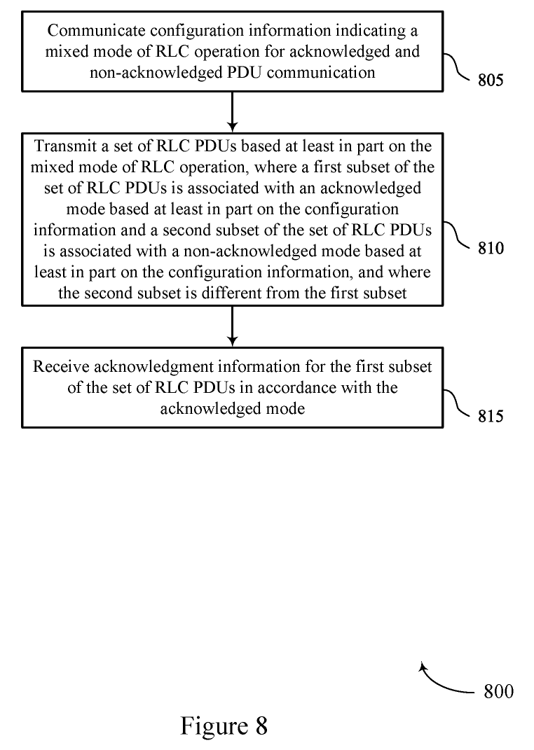

FIG. 8 shows a flowchart illustrating a method 800 that supports acknowledged and non-acknowledged communications. The operations of the method 800 may be implemented by a device or its components as described herein. For example, the operations of the method 800 may be performed by a device as described with reference to FIGS. 1 through 7. In some examples, a device may execute a set of instructions to control the functional elements of the device to perform the described functions. Additionally, or alternatively, the device may perform aspects of the described functions using special-purpose hardware.

At 805, the method may include communicating configuration information indicating a mixed mode of RLC operation for acknowledged and non-acknowledged PDU communication. In some examples, aspects of the operations of 805 may be performed by a configuration component 625.

At 810, the method may include transmitting a set of RLC PDUs based at least in part on the mixed mode of RLC operation, where a first subset of the set of RLC PDUs is associated with an acknowledged mode based at least in part on the configuration information and a second subset of the set of RLC PDUs is associated with a non-acknowledged mode based at least in part on the configuration information, and where the second subset is different from the first subset. In some examples, aspects of the operations of 810 may be performed by a mode component 630.

At 815, the method may include receiving acknowledgment information for the first subset of the set of RLC PDUs in accordance with the acknowledged mode. In some examples, aspects of the operations of 815 may be performed by an acknowledgment component 635.

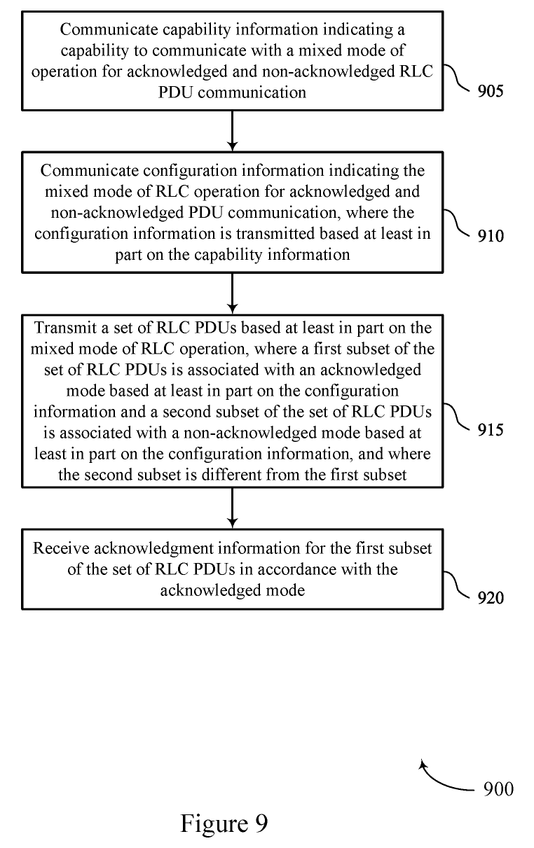

FIG. 9 shows a flowchart illustrating a method 900 that supports acknowledged and non-acknowledged communications. The operations of the method 900 may be implemented by a device or its components as described herein. For example, the operations of the method 900 may be performed by a device as described with reference to FIGS. 1 through 7. In some examples, a device may execute a set of instructions to control the functional elements of the device to perform the described functions. Additionally, or alternatively, the device may perform aspects of the described functions using special-purpose hardware.

At 905, the method may include communicating capability information indicating a capability to communicate with a mixed mode of operation for acknowledged and non-acknowledged RLC PDU communication. In some examples, aspects of the operations of 905 may be performed by a capability component 640.

At 910, the method may include communicating configuration information indicating the mixed mode of RLC operation for acknowledged and non-acknowledged PDU communication, where the configuration information is transmitted based at least in part on the capability information. In some examples, aspects of the operations of 910 may be performed by a configuration component 625.

At 915, the method may include transmitting a set of RLC PDUs based at least in part on the mixed mode of RLC operation, where a first subset of the set of RLC PDUs is associated with an acknowledged mode based at least in part on the configuration information and a second subset of the set of RLC PDUs is associated with a non-acknowledged mode based at least in part on the configuration information, and where the second subset is different from the first subset. In some examples, aspects of the operations of 915 may be performed by a mode component 630.

At 920, the method may include receiving acknowledgment information for the first subset of the set of RLC PDUs in accordance with the acknowledged mode. In some examples, aspects of the operations of 920 may be performed by an acknowledgment component 635.

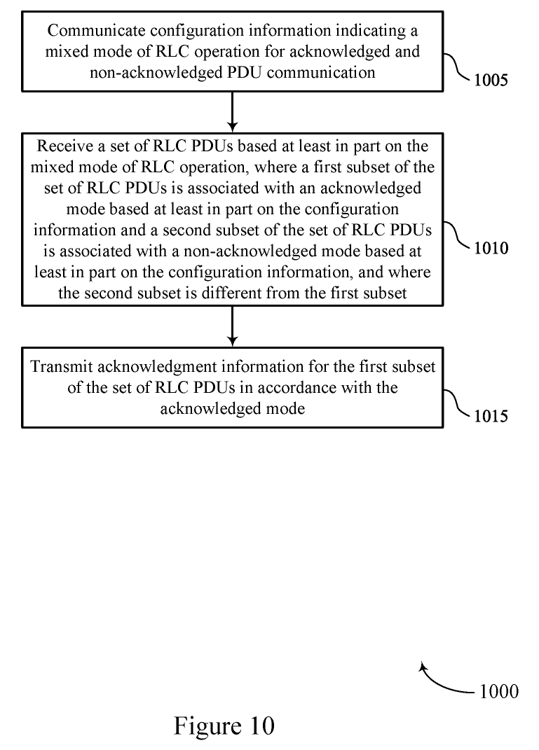

FIG. 10 shows a flowchart illustrating a method 1000 that supports acknowledged and non-acknowledged communications. The operations of the method 1000 may be implemented by a device or its components as described herein. For example, the operations of the method 1000 may be performed by a device as described with reference to FIGS. 1 through 7. In some examples, a device may execute a set of instructions to control the functional elements of the device to perform the described functions. Additionally, or alternatively, the device may perform aspects of the described functions using special-purpose hardware.

At 1005, the method may include communicating configuration information indicating a mixed mode of RLC operation for acknowledged and non-acknowledged PDU communication. In some examples, aspects of the operations of 1005 may be performed by a configuration component 625.

At 1010, the method may include receiving a set of RLC PDUs based at least in part on the mixed mode of RLC operation, where a first subset of the set of RLC PDUs is associated with an acknowledged mode based at least in part on the configuration information and a second subset of the set of RLC PDUs is associated with a non-acknowledged mode based at least in part on the configuration information, and where the second subset is different from the first subset. In some examples, aspects of the operations of 1010 may be performed by a mode component 630.

At 1015, the method may include transmitting acknowledgment information for the first subset of the set of RLC PDUs in accordance with the acknowledged mode. In some examples, aspects of the operations of 1015 may be performed by an acknowledgment component 635.

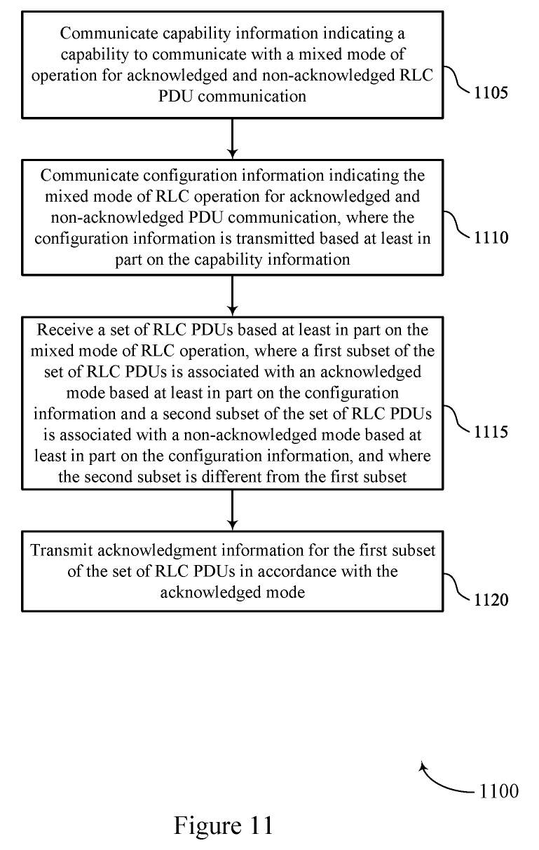

FIG. 11 shows a flowchart illustrating a method 1100 that supports acknowledged and non-acknowledged communications. The operations of the method 1100 may be implemented by a device or its components as described herein. For example, the operations of the method 1100 may be performed by a device as described with reference to FIGS. 1 through 7. In some examples, a device may execute a set of instructions to control the functional elements of the device to perform the described functions. Additionally, or alternatively, the device may perform aspects of the described functions using special-purpose hardware.

At 1105, the method may include communicating capability information indicating a capability to communicate with a mixed mode of operation for acknowledged and non-acknowledged RLC PDU communication. In some examples, aspects of the operations of 1105 may be performed by a capability component 640.

At 1110, the method may include communicating configuration information indicating the mixed mode of RLC operation for acknowledged and non-acknowledged PDU communication, where the configuration information is transmitted based at least in part on the capability information. In some examples, aspects of the operations of 1110 may be performed by a configuration component 625.

At 1115, the method may include receiving a set of RLC PDUs based at least in part on the mixed mode of RLC operation, where a first subset of the set of RLC PDUs is associated with an acknowledged mode based at least in part on the configuration information and a second subset of the set of RLC PDUs is associated with a non-acknowledged mode based at least in part on the configuration information, and where the second subset is different from the first subset. In some examples, aspects of the operations of 1115 may be performed by a mode component 630.

At 1120, the method may include transmitting acknowledgment information for the first subset of the set of RLC PDUs in accordance with the acknowledged mode. In some examples, aspects of the operations of 1120 may be performed by an acknowledgment component 635.

Implementation examples are described in the following numbered clauses:

Aspect 1: A method for wireless communications by a device, comprising: communicating configuration information indicating a mixed mode of RLC operation for acknowledged and non-acknowledged PDU communication; transmitting a set of RLC PDUs based at least in part on the mixed mode of RLC operation, wherein a first subset of the set of RLC PDUs is associated with an acknowledged mode based at least in part on the configuration information and a second subset of the set of RLC PDUs is associated with a non-acknowledged mode based at least in part on the configuration information, and wherein the second subset is different from the first subset; and receiving acknowledgment information for the first subset of the set of RLC PDUs in accordance with the acknowledged mode.

Aspect 2: The method of aspect 1, wherein transmitting the set of RLC PDUs comprises transmitting a first RLC PDU of the set of RLC PDUs with a sequence number and a second RLC PDU of the set of RLC PDUs without a sequence number, and receiving the acknowledgment information comprises receiving ACK/NACK information corresponding to the first RLC PDU.

Aspect 3: The method of any of aspects 1 through 2, the method further comprising: receiving an indication of a quantity of received RLC PDUs of the second subset, wherein a first quantity of acknowledged PDUs and a second quantity of non-acknowledged RLC PDUs are based at least in part on a probability corresponding to a PER of the quantity of received RLC PDUs.

Aspect 4: The method of any aspect 1, wherein the first subset of the set of RLC PDUs and the second subset of the set of RLC PDUs are communicated with sequence numbers, the method further comprising: receiving a NACK for one or more RLC PDUs of the first subset of the set of RLC PDUs; and transmitting the one or more RLC PDUs of the first subset of the set of RLC PDUs.

Aspect 5: The method of any of aspects 1 through 4, the method further comprising: receiving a NACK for a subset of unsuccessfully received RLC PDUs, wherein the subset of unsuccessfully received RLC PDUs is based at least in part on a response probability associated with the set of RLC PDUs.

Aspect 6: The method of aspect 5, wherein the response probability is indicated via the configuration information.

Aspect 7: The method of any of aspects 5 through 6, wherein the response probability is from a range of response probabilities, and the range of response probabilities is indicated via the configuration information.

Aspect 8: The method of any of aspects 1 through 7, wherein an RLC PDU of the set of RLC PDUs is associated with one of the acknowledged mode or the non-acknowledged mode based at least in part on a rule at an RLC layer after a SDU corresponding to the RLC PDU is submitted from a PDCP layer to the RLC layer.

Aspect 9: The method of aspect 8, wherein the rule comprises a threshold that is indicated via the configuration information, and the RLC PDU of the set of RLC PDUs is communicated in accordance with one of the acknowledged mode or the non-acknowledged mode based at least in part on whether a PDU set importance (PSI) of the RLC PDU satisfies the threshold.

Aspect 10: The method of any of aspects 8 through 9, wherein the rule is based at least in part on a PDU type condition, and the RLC PDU of the set of RLC PDUs is communicated in accordance with one of the acknowledged mode or the non-acknowledged mode based at least in part on whether a type of the RLC PDU satisfies the PDU type condition.

Aspect 11: The method of any of aspects 8 through 10, further comprising: generating a random quantity, wherein the rule is based at least in part on a probability, and the RLC PDU of the set of RLC PDUs is communicated in accordance with one of the acknowledged mode or the non-acknowledged mode based at least in part on a comparison of the probability and the random quantity.

Aspect 12: The method of aspect 11, wherein the probability is indicated via the configuration information.

Aspect 13: The method of any of aspects 11 through 12, wherein a range of probabilities is indicated via the configuration information.

Aspect 14: The method of any of aspects 1 through 13, wherein the first subset of the set of RLC PDUs is communicated with one or more sequence numbers and the second subset of the set of RLC PDUs is communicated without a sequence number.

Aspect 15: The method of any of aspects 1 through 14, wherein the configuration information indicates a probability of an RLC PDU of the set of RLC PDUs being an acknowledged RLC PDU or a non-acknowledged RLC PDU.

Aspect 16: The method of any of aspects 1 through 15, further comprising: communicating capability information indicating a capability to communicate with the mixed mode of operation for acknowledged and non-acknowledged RLC PDU communication, wherein the configuration information is transmitted based at least in part on the capability information.

Aspect 17: A method for wireless communications by a device, comprising: communicating configuration information indicating a mixed mode of RLC operation for acknowledged and non-acknowledged PDU communication; receiving a set of RLC PDUs based at least in part on the mixed mode of RLC operation, wherein a first subset of the set of RLC PDUs is associated with an acknowledged mode based at least in part on the configuration information and a second subset of the set of RLC PDUs is associated with a non-acknowledged mode based at least in part on the configuration information, and wherein the second subset is different from the first subset; and transmitting acknowledgment information for the first subset of the set of RLC PDUs in accordance with the acknowledged mode.

Aspect 18: The method of aspect 17, wherein receiving the set of RLC PDUs comprises receiving a first RLC PDU of the set of RLC PDUs with a sequence number and a second RLC PDU of the set of RLC PDUs without a sequence number, and transmitting the acknowledgment information comprises transmitting ACK/NACK information corresponding to the first RLC PDU.

Aspect 19: The method of any of aspects 17 through 18, the method further comprising: transmitting an indication of a quantity of received RLC PDUs of the second subset, wherein a first quantity of acknowledged PDUs and a second quantity of non-acknowledged RLC PDUs are based at least in part on a probability corresponding to a PER of the quantity of received RLC PDUs.

Aspect 20: The method of any of aspects 17 through 19, the method further comprising: transmitting a NACK for a subset of unsuccessfully received RLC PDUs, wherein the subset of unsuccessfully received RLC PDUs is based at least in part on a response probability associated with the set of RLC PDUs.

Aspect 21: The method of aspect 20, wherein the response probability is indicated via the configuration information.

Aspect 22: The method of any of aspects 20 through 21, wherein the response probability is from a range of response probabilities, and the range of response probabilities is indicated via the configuration information.

Aspect 23: The method of any of aspects 17 through 22, wherein an RLC PDU of the set of RLC PDUs is associated with one of the acknowledged mode or the non-acknowledged mode based at least in part on a rule at an RLC layer after a SDU corresponding to the RLC PDU is submitted from a PDCP layer to the RLC layer.

Aspect 24: The method of any of aspects 17 through 23, wherein the first subset of the set of RLC PDUs is communicated with one or more sequence numbers and the second subset of the set of RLC PDUs is communicated without a sequence number.

Aspect 25: The method of any of aspects 17 through 24, wherein the configuration information indicates a probability of an RLC PDU of the set of RLC PDUs being an acknowledged RLC PDU or a non-acknowledged RLC PDU.

Aspect 26: The method of any of aspects 17 through 25, further comprising: communicating capability information indicating a capability to communicate with the mixed mode of operation for acknowledged and non-acknowledged RLC PDU communication, wherein the configuration information is transmitted based at least in part on the capability information.

Aspect 27: A device comprising a processing system that includes processor circuitry and memory circuitry that stores code, the processing system configured to cause the device to perform a method of any of aspects 1 through 16.

Aspect 28: A device comprising at least one means for performing a method of any of aspects 1 through 16.

Aspect 29: A non-transitory computer-readable medium storing code the code comprising instructions executable by one or more processors to perform a method of any of aspects 1 through 16.

Aspect 30: A device comprising a processing system that includes processor circuitry and memory circuitry that stores code, the processing system configured to cause the device to perform a method of any of aspects 17 through 26.

Aspect 31: A device comprising at least one means for performing a method of any of aspects 17 through 26.

Aspect 32: A non-transitory computer-readable medium storing code the code comprising instructions executable by one or more processors to perform a method of any of aspects 17 through 26.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A device, comprising:
a processing system that includes processor circuitry and memory circuitry that stores code, the processing system configured to cause the device to:
communicate configuration information indicating a mixed mode of radio link control (RLC) operation for acknowledged and non-acknowledged protocol data unit (PDU) communication;
transmit a set of RLC PDUs based at least in part on the mixed mode of RLC operation, wherein a first subset of the set of RLC PDUs is associated with an acknowledged mode based at least in part on the configuration information and a second subset of the set of RLC PDUs is associated with a non-acknowledged mode based at least in part on the configuration information, and wherein the second subset is different from the first subset; and
receive acknowledgment information for the first subset of the set of RLC PDUs in accordance with the acknowledged mode.

2. The device of claim 1, wherein, to transmit the set of RLC PDUs, the processing system is configured to cause the device to transmit a first RLC PDU of the set of RLC PDUs with a sequence number and a second RLC PDU of the set of RLC PDUs without a sequence number, and wherein, to receive the acknowledgment information, the processing system is configured to cause the device to receive the acknowledgment information, wherein the processing system is configured to cause the device to receive acknowledgment or negative acknowledgment (ACK/NACK) information corresponding to the first RLC PDU.

3. The device of claim 1, wherein the processing system is further configured to cause the device to:
receive a negative acknowledgment (NACK) for one or more RLC PDUs of the first subset of the set of RLC PDUs; and
transmit the one or more RLC PDUs of the first subset of the set of RLC PDUs.

4. The device of claim 1, wherein the processing system is further configured to cause the device to:
receive a negative acknowledgment (NACK) for a subset of unsuccessfully received RLC PDUs, wherein the subset of unsuccessfully received RLC PDUs is based at least in part on a response probability associated with the set of RLC PDUs, wherein the response probability is indicated via the configuration information, wherein the response probability is from a range of response probabilities, and the range of response probabilities is indicated via the configuration information.

5. The device of claim 1, wherein an RLC PDU of the set of RLC PDUs is associated with one of the acknowledged mode or the non-acknowledged mode based at least in part on a rule at an RLC layer after a service data unit (SDU) corresponding to the RLC PDU is submitted from a packet data convergence protocol (PDCP) layer to the RLC layer.

6. The device of claim 5, wherein the rule comprises a threshold that is indicated via the configuration information, and the RLC PDU of the set of RLC PDUs is communicated in accordance with one of the acknowledged mode or the non-acknowledged mode based at least in part on whether a PDU set importance (PSI) of the RLC PDU satisfies the threshold.

7. The device of claim 5, wherein the rule is based at least in part on a PDU type condition, and the RLC PDU of the set of RLC PDUs is communicated in accordance with one of the acknowledged mode or the non-acknowledged mode based at least in part on whether a type of the RLC PDU satisfies the PDU type condition.

8. The device of claim 5, wherein the processing system is further configured to cause the device to:
generate a random quantity, wherein the rule is based at least in part on a probability, and the RLC PDU of the set of RLC PDUs is communicated in accordance with one of the acknowledged mode or the non-acknowledged mode based at least in part on a comparison of the probability and the random quantity, wherein the probability is indicated via the configuration information or a range of probabilities is indicated via the configuration information.

9. The device of claim 1, wherein the first subset of the set of RLC PDUs is communicated with one or more sequence numbers and the second subset of the set of RLC PDUs is communicated without a sequence number.

10. The device of claim 1, wherein the configuration information indicates a probability of an RLC PDU of the set of RLC PDUs being an acknowledged RLC PDU or a non-acknowledged RLC PDU.

11. A device, comprising:
a processing system that includes processor circuitry and memory circuitry that stores code, the processing system configured to cause the device to:
communicate configuration information indicating a mixed mode of radio link control (RLC) operation for acknowledged and non-acknowledged protocol data unit (PDU) communication;
receive a set of RLC PDUs based at least in part on the mixed mode of RLC operation, wherein a first subset of the set of RLC PDUs is associated with an acknowledged mode based at least in part on the configuration information and a second subset of the set of RLC PDUs is associated with a non-acknowledged mode based at least in part on the configuration information, and wherein the second subset is different from the first subset; and
transmit acknowledgment information for the first subset of the set of RLC PDUs in accordance with the acknowledged mode.

12. The device of claim 11, wherein, to receive the set of RLC PDUs, the processing system is configured to cause the device to receive a first RLC PDU of the set of RLC PDUs with a sequence number and a second RLC PDU of the set of RLC PDUs without a sequence number, and wherein, to transmit the acknowledgment information, the processing system is configured to cause the device to transmit acknowledgment or negative acknowledgment (ACK/NACK) information corresponding to the first RLC PDU.

13. The device of claim 11, wherein the processing system is further configured to cause the device to:
transmit a negative acknowledgment (NACK) for a subset of unsuccessfully received RLC PDUs, wherein the subset of unsuccessfully received RLC PDUs is based at least in part on a response probability associated with the set of RLC PDUs, wherein the response probability is indicated via the configuration information, wherein the response probability is from a range of response probabilities, and the range of response probabilities is indicated via the configuration information.

14. The device of claim 11, wherein an RLC PDU of the set of RLC PDUs is associated with one of the acknowledged mode or the non-acknowledged mode based at least in part on a rule at an RLC layer after a service data unit (SDU) corresponding to the RLC PDU is submitted from a packet data convergence protocol (PDCP) layer to the RLC layer.

15. The device of claim 11, wherein the first subset of the set of RLC PDUs is communicated with one or more sequence numbers and the second subset of the set of RLC PDUs is communicated without a sequence number.

16. The device of claim 11, wherein the configuration information indicates a probability of an RLC PDU of the set of RLC PDUs being an acknowledged RLC PDU or a non-acknowledged RLC PDU.

17. A method for wireless communications by a device, comprising:
communicating configuration information indicating a mixed mode of radio link control (RLC) operation for acknowledged and non-acknowledged protocol data unit (PDU) communication;
transmitting a set of RLC PDUs based at least in part on the mixed mode of RLC operation, wherein a first subset of the set of RLC PDUs is associated with an acknowledged mode based at least in part on the configuration information and a second subset of the set of RLC PDUs is associated with a non-acknowledged mode based at least in part on the configuration information, and wherein the second subset is different from the first subset; and
receiving acknowledgment information for the first subset of the set of RLC PDUs in accordance with the acknowledged mode.

18. The method of claim 17, wherein transmitting the set of RLC PDUs comprises transmitting a first RLC PDU of the set of RLC PDUs with a sequence number and a second RLC PDU of the set of RLC PDUs without a sequence number, and wherein receiving the acknowledgment information comprises receiving acknowledgment or negative acknowledgment (ACK/NACK) information corresponding to the first RLC PDU.

19. The method of claim 17, wherein the first subset of the set of RLC PDUs and the second subset of the set of RLC PDUs are communicated with sequence numbers, the method further comprising:
receiving a negative acknowledgment (NACK) for one or more RLC PDUs of the first subset of the set of RLC PDUs; and
transmitting the one or more RLC PDUs of the first subset of the set of RLC PDUs.

20. The method of claim 17, the method further comprising:
receiving a negative acknowledgment (NACK) for a subset of unsuccessfully received RLC PDUs, wherein the subset of unsuccessfully received RLC PDUs is based at least in part on a response probability associated with the set of RLC PDUs.
